(19) United States
(12) Patent Application Publication
(10) Pub. No.: US 2007/0070178 A1
(43) Pub. Date: Mar. 29, 2007

(54) Method and system for communicating in a wireless communications network

(75) Inventor: Mohan Singh Maghera, Luton (GB)

Correspondence Address: BAKER & BOTTS L.L.P., 30 ROCKEFELLER PLAZA, 44TH FLOOR, NEW YORK, NY, 10112-4498, US

(73) Assignee: BROADCM CORPORATION, IRVINE, CA (US)

(21) Appl. No.: 10/485,446

(22) PCT Filed: Aug. 6, 2002
(86) PCT No.: PCT/DE02/02890

§ 371 Date: Aug. 18, 2006

(30) Foreign Application Priority Data
Aug. 6, 2001 (DE) 101 37 787.8

(51) Int. Cl. H04N 7/14

(52) U.S. Cl. 348/14.02; 348/14.01

(57) ABSTRACT

A system and method for wireless network communications with a portable communication instrument. The portable communication instrument can be a personal mobile phone. The communications can include voice, video or text information. The information is transmitted from a transmitter in the wireless network to the portable communication instrument over a wireless link. The personal communication instrument is additionally coupled to a stationary unit having display characteristics other than those of the personal communication instrument. At least a portion of the information received at the portable communication instrument is retransmitted to the stationary unit for output, for example, on an improved or larger display.

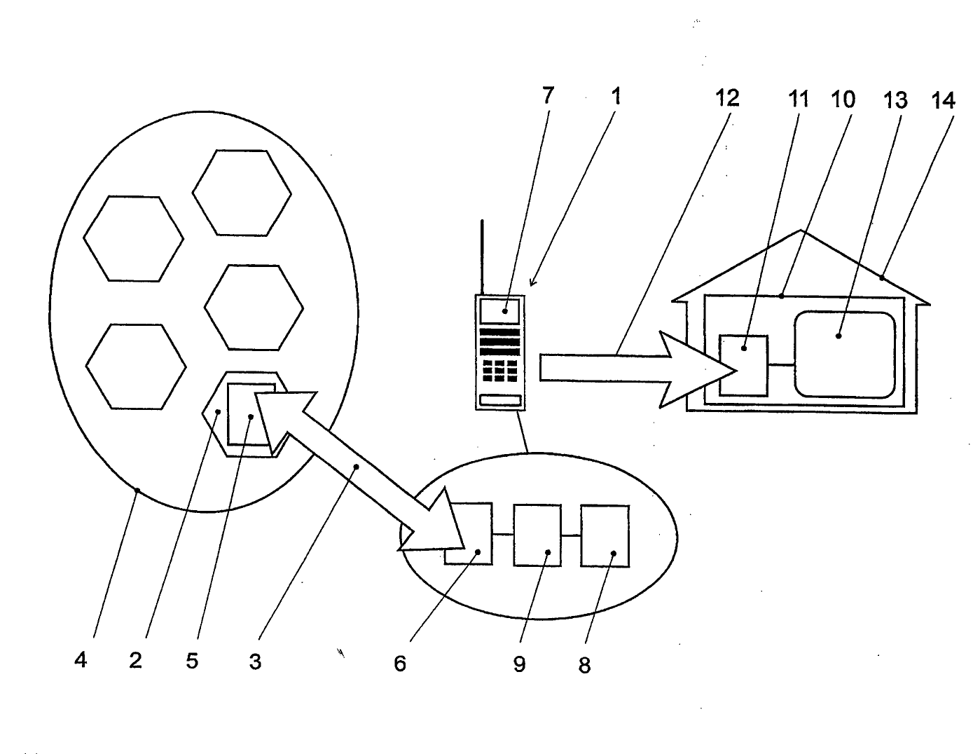

### BACKGROUND OF THE INVENTION

The invention relates to a method for communication in a wireless communication network, wherein a portable communication instrument is connected during a connection with a stationary communication means via a first wireless communication channel which forms part of a first communication network and which has a first information bandwidth. Communication information that is received via the communication channel is output to the transportable communication instrument.

The invention likewise relates to a system for communication in a wireless communication network with a transportable communication instrument that has a first transmitting and receiving unit and at least one first information output unit, and with a first stationary communication means which forms part of a first communication network and which has a second transmitting and receiving unit that corresponds with the first transmitting and receiving unit.

The system mentioned at the beginning and the associated method are well known in generally known radiotelephone networks. Here a portable communication instrument is connected during a connection with a stationary communication means, for example a converter, via a first wireless communication channel that forms part of the radiotelephone network. The information bandwidth available there is sufficient to transmit speech, video or text information. Communication information that is received via the communication channel, i.e., speech, video and text information, is output to the portable communication instrument.

For more independent handling of a radiotelephone or similar communication instrument, under the trade name “Bluetooth” it is known that communication information may be transmitted in wireless fashion to a second lighter portable communication instrument which may be worn for example on the head. This makes it possible to carry on a telephone conversation independent of the radiotelephone.

In addition, for the replacement of wired local area networks (LAN=local area network) it is known that a wireless local area network (W-LAN=wireless local area network) may be produced by fixed wireless access (FWA=fixed wireless access). Here communication information in the microwave region is transmitted between communication instruments. Coupling of the local area network with an additional network, for instance a wireless global network (W-WAN=wireless wide area network), is not known. The FWA method also has the disadvantage of a relatively narrow bandwidth and the necessity of quasi-visual contact between the network participants.

With the increasing production of W-WANs in particular through the use of new coding techniques, it becomes possible to transmit, in addition to audio information, video information as well. This video information may be shown in a display. Thus, for example, videoconferences are possible via cellphone. In these cases, however, it is disadvantageous that the displays—due to the size of the cellphone—are usually quite small and are also provided with a low resolution. This makes the representation of video information hard to see.

The object of the invention is now to improve representation of the communication information received. This object is accomplished in regard to the method in that the communication information is transmitted in the form of digitized video and audio information at a first information bandwidth. The transportable communication instrument is connected via a second wireless communication channel, which has a second information bandwidth, with a second stationary communication means. At least some of the communication information is transmitted to the second stationary communication means and is output there. At the same time, the second information bandwidth is at least equal to the first information bandwidth.

It is possible, for one thing, to transmit data of considerable volume in communication networks that work for example by CDMA (code division multiple access), with very great bandwidth. Because of the abundance of information on the transportable communication instrument, this information can be brought to output only incompletely or not at all. If for example video transmissions are made to a cellphone, they are only poorly reproduced on the relatively small display of the cellphone. Owing to the fact that the transportable communication instrument is connected with the second stationary communication means, this video information from the cellphone can now be brought to display on a large screen. Since the second information bandwidth is at least equal to the first information bandwidth, full information is brought to output.

In one embodiment of the method it is provided that the communication information consists of audio and video information and that the audio and/or video information is transmitted to the second stationary communication means and is output there.

Here there is the possibility of differentiating between the output types audio, video, video and audio. Thus, for example, the reproduction of films with stereo-surround sound is also possible.

In another embodiment of the method it is provided that the second communication channel forms part of a second communication network.

In an existing LAN it may be advantageous to feed the communication information received directly into the network. In a wired LAN this may be done in that the second stationary communication means is likewise a participant in the LAN. Thus the information transmitted wireless from the transportable communication instrument to the second communication channel may be received by the second stationary communication means and retransmitted to the LAN.

The same method may of course also be accomplished in a W-LAN. However, here it is alternatively possible that the transportable communication instrument is a direct participant in the W-LAN and the communication information is transmitted via the W-LAN to the second stationary communication means.

The method alternatively is refined in that the second information bandwidth is equal to or greater than the first information bandwidth and in that the communication information received in the transportable communication instrument is converted to the transmission format of the second communication channel.

Communication information thus is processed in the transportable instrument. Here a variety of modes of operation are possible. The transportable communication instrument may for example temporarily store data that arrive with a small first data bandwidth and retransmit them with a greater second data bandwidth. The conversion of communication information is also advantageous, since as a rule the protocols of the first and the second communication channels are unlike. Thus the general method is usable even for such unlike protocols.

It is in addition possible to design the method so that the connection of the transportable communication instrument with the second stationary communication means is automatically produced when the transportable communication instrument has gotten into the range of the second stationary communication means.

This results in automatic switching from operation in the first communication channel to operation in the first and second communication channel. If, for example, a cellphone has produced a videoconference connection, the user may go into the operating range of the second communication channel and then, upon continuation of the communication connection, continue to follow the videoconference on a large monitor, such as for example on a wall-mounted plasma screen.

In terms of the system, the purpose according to the invention is accomplished in that a second stationary communication means, which has a second information output unit and a receiving unit, is provided and in that the transportable communication instrument is provided with a transmitting unit that corresponds with a receiving unit and with an interface between the second transmitting and receiving unit and the transmitting unit.

In addition to the first transmitting and receiving unit, the transportable communication instrument also has at least one additional transmitting unit. Via the interface the communication information that has been received on the first communication channel is then sent to the transmitting unit, which then transmits the communication information to the receiving unit in the stationary communication means. It may then, in addition for example to being output on the first information output unit, be output on the second information output unit.

In a preferred embodiment of the system it is provided that a first W-LAN interface, which communicates with a second W-LAN interface in the second stationary communication means, may be integrated into the transportable communication instrument.

Such W-LAN interfaces are to be produced in a size that can be well integrated physically into a fairly small transportable communication instrument. Also, there are no problems in providing the necessary energy.

The system according to the invention may be refined in that the second stationary communication means forms part of a second communication network.

Thus the transportable communication instrument itself may be a participant in for example a W-LAN.

An additional embodiment of the invention is characterized in that the first information output unit contains a first screen and the second information output unit contains a second screen, the second screen being larger than the first screen.

The reproduction of video information is thus considerably facilitated.

Lastly, the system is refined in that the transmitting unit forms part of a third transmitting and receiving unit and the receiving unit forms part of a fourth transmitting and receiving unit.

This embodiment permits the second communication channel to be used not only for transmission of communication information to the second stationary communication means, but also vice-versa. Thus, for example, microphones may be installed in a conference room, by means of which speech input takes place, which is then retransmitted by the second communication channel to the transportable communication instrument.

The invention is to be explained in detail below by an example. The accompanying drawing shows a basic representation of the invention.

In the example the transportable communication instrument 1 is designed as a cellphone. The transportable communication instrument 1 is connected with a first stationary communication means 2 via a first communication channel 3. The first stationary communication means 2 is a member of a first communication network 4, in this case a radiotelephone network designed as a W-WAN.

A videoconference is connected between the first stationary communication means 2 and the transportable communication instrument 1, i.e., audio and video data are exchanged via the first communication channel 3. For this purpose, a first transmitting and receiving unit 5 in the first stationary communication means 2 is in connection with a second transmitting and receiving unit 6 in the transportable communication instrument 1. At the same time the video information is displayed on a first information output unit 7 in the transportable communication instrument 1, albeit in not very satisfactory size and quality.

A transmitting unit 8 is likewise located in the transportable communication instrument 1. This is connected via an interface 9 with the second transmitting and receiving unit 6. This allows communication information that is received from the second transmitting and receiving unit 6 to be transmitted to the transmitting unit 8.

A second stationary communication means 10 is also provided in the system. This is provided with a receiving unit 11.

The transmitting unit 8 now transmits the communication information, via a second communication channel 12, to the receiving unit 11. At the same time the communication information in the interface 9 is converted to a format that corresponds to the protocol in the second communication channel 12.

A second information output 13 is located in the second stationary communication means 10. The communication information is then output to the latter in a better size and quality. This second information output unit 10 is a large plasma screen, attached to the wall, with a stereo-audio reproduction system. The receiving unit 11 is connected to this in suitable fashion in the second stationary communication means 10 with the receiving unit 11.

The second stationary communication means 10 forms part of a second communication network 14, in the form of a W-LAN. At the same time, the connection in the second communication channel 12 is automatically produced when the transportable communication instrument 1 comes into the receiving range of the second communication network 14. This enables a person, while the connection via the first communication channel 3 is produced, to enter the receiving range of the second communication network 14 in order thus to be able follow the videoconference in substantially better quality.

List of Reference Numerals

1. Transportable communication instrument

2. First stationary communication means

3. First communication channel

4. First communication network

5. First transmitting and receiving unit

6. Second transmitting and receiving unit

7. First information output unit

8. Transmitting unit

9. Interface

10. Second stationary communication means

11. Receiving unit

12. Second communication channel

13. Second information output unit

14. Second communication network

1-10. (canceled)

11. A method for communication in a wireless communication network, comprising:
receiving digitized communication information at a portable communication instrument from a first stationary communication means over a first wireless link; and
retransmitting at least a portion of the received digitized communication information to a second stationary communication means over a second wireless link for display on the second stationary communication means.

12. A method for communication in a wireless communication network, comprising:
connecting a portable communication instrument to a first stationary communication means via a first wireless communication channel having a first information bandwidth so that the portable communication instrument receives digitized communication information from the first stationary communication means;
further, connecting the portable communication instrument to a second stationary communication means via a second wireless communication channel having a second information bandwidth, wherein the second information bandwidth is not less than about the first information bandwidth; and
retransmitting at least a portion of the digitized communication information received by the portable communication instrument to the second stationary communication means.

13. The method of claim 12 wherein the digitized communication information received by the portable communication instrument comprises audio and video information, and wherein at least a portion of the audio and video information is retransmitted to the second stationary communication means, further comprising displaying the retransmitted information at the second stationary communication means.

14. The method of claim 12 further comprising providing the second communication channel as a part of a second communication network.

15. The method of claim 12 wherein the second information bandwidth is greater than the first information bandwidth, further comprising reformatting the digitized communication information received at the portable communication means to a transmission format of the second communication channel.

16. The method of claim 12 wherein connecting the portable communication instrument to a second stationary communication means via a second wireless communication channel having a second information bandwidth, comprises providing an automatic connection when the portable communication instrument is in a range of the second stationary communication means.

17. A wireless communication system comprising:
a first stationary communication means comprising a first transmitting and receiving unit, wherein the first stationary communication means is part of a first wireless network;
a second stationary communication means comprising:
a fourth receiving unit; and,
a second information output unit; and
a portable communication unit comprising:
a second transmitting and receiving unit for communication with the first transmitting and receiving unit;
a first information output; and
a third transmitting unit for communicating with the fourth receiving unit.

18. The system of claim 17 wherein the portable communication instrument further comprises an interface between the second transmitting and receiving unit and the third transmitting unit.

19. The system of claim 17 wherein the portable communication instrument comprises a first W-LAN interface for communication with a second W-LAN interface in the second stationary communication means.

20. The system of claim 17 wherein the second stationary communication means is part of a second wireless communication network.

21. The system of claim 17 wherein the first information output unit comprises a first screen and the second information output unit comprises a second screen, wherein the second screen is larger than the first screen.

22. The system of claim 17 wherein the portable communication unit further comprises a third receiving unit that is paired with the third transmitting unit, and wherein the second stationary communication means further comprises a fourth transmitting unit that is paired with the fourth receiving unit.
